(19) United States
(12) Patent Application Publication
(10) Pub. No.: US 2016/0065634 A1
(43) Pub. Date: Mar. 3, 2016

(54) SYSTEM AND METHOD FOR INTEGRATING SOCIAL MEDIA AND BROADCASTING

(71) Applicant: Christopher Martin Pati, Ronkonkoma, NY (US)

(72) Inventor: Christopher Martin Pati, Ronkonkoma, NY (US)

(21) Appl. No.: 14/843,017

(22) Filed: Sep. 2, 2015

Related U.S. Application Data
(60) Provisional application No. 62/044,559, filed on Sep. 2, 2014.

(51) Int. Cl. H04L 29/06; H04L 29/08

(52) U.S. Cl. CPC H04L 65/4076; H04L 67/02; H04L 67/22

(57) ABSTRACT

A method for distributing broadcast media over the internet includes providing a website containing a single genre of broadcast content via software executing on a computer is provided. The method generates a website account for at least one media consumer via software executing on a computer. The method further includes displaying broadcast content to at least one consumer via software executing on a computer. The method further includes querying at least one consumer for personal information and comments on the content via software executing on a computer. The method further includes tracking the activities of at least one consumer via software executing on a computer. The method further includes transmitting the tracked activities to a third party.

### CROSS-REFERENCE TO RELATED APPLICATION

This application claims the benefit of priority of U.S. provisional application No. 62/044,559, filed Sep. 2, 2014, the contents of which are herein incorporated by reference.

### BACKGROUND OF THE INVENTION

The system and method described herein relate to the field of online content delivery; specifically, to the field of social media.

### BACKGROUND

Social media and broadcasting are done on two separate platforms and thus utilize twice the manpower and resources and fail to provide immediate or direct interaction with the viewer/customer. Social Media and 24/7 live streaming broadcasting together on a business model does not exist yet. The two only exist as separate portals/platforms.

Facebook and Twitter control all aspects of their members' interactions and retain all data. Individuals or companies broadcasting content that interact with their customers/viewers through third-party social media sites do not get direct access to the viewer/user. The social media portal gets all the valuable traffic and information and does not share it with the members/users.

As a result, there is a lack of immediacy or synergy when third party social media is used in conjunction with broadcast. The metrics and stats are not directly reflected in either platform, so by being separate models there is no cross platform unity or synergy in the metrics hence both must be interpreted separately and assimilated to understand the others relevance with regard to audience success and engagement.

Moreover, the current models (Facebook, Twitter, etc. . . . ) are not customizable or modifiable by the user.

There is a need in the art for a platform that integrates social media and broadcasting and is user-customizable.

### SUMMARY OF THE INVENTION

In one aspect of the present invention, a method for distributing broadcast media over the internet includes providing a website containing broadcast content via software executing on a computer; generating a website account for at least one media consumer via software executing on a computer; displaying broadcast content to the at least one media consumer via software executing on a computer; and tracking the activities of the at least one media consumer via software executing on a computer.

In another aspect of the present invention, a method for distributing broadcast media over the internet includes providing a website containing a single genre of broadcast content via software executing on a computer; generating a website account for at least one media consumer via software executing on a computer; displaying broadcast content to the at least one media consumer via software executing on a computer; querying the at least one media consumer for personal information and comments on the content via software executing on a computer; tracking the activities of the at least one media consumer via software executing on a computer; and transmitting the tracked activities to a third party.

In another aspect of the present invention, the above method further includes the broadcast content comprising ad content, wherein the ad content is provided by at least one ad server and the broadcast content is provided by at least one cdn server, and wherein each ad server and cdn server are merged at the code level.

These and other features, aspects and advantages of the present invention will become better understood with reference to the following drawings, description and claims.

### BRIEF DESCRIPTION OF THE DRAWINGS

FIG. 1 is a diagram of an exemplary embodiment of the present invention;

FIG. 2 is a screen view of a broadcast video player tile frame shown on a homepage of an exemplary embodiment of the present invention;

FIG. 3 is a general site map of an exemplary embodiment of the present invention;

FIG. 4 is a site map of a member's section of an exemplary embodiment of the present invention;

FIG. 5 is a screen view of a timeline social media display of an exemplary embodiment of the present invention;

FIG. 6 is a screen view of a image/video tile broadcast display of an exemplary embodiment of the present invention;

FIG. 7 is a screen view of word/tag cloud tile display of an exemplary embodiment of the present invention; and

FIG. 8 is a screen view of a video tile broadcast display of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for distributing broadcast media over the internet includes providing a website containing a single genre of broadcast content via software executing on a computer by generating a website account for at least one media consumer via software executing on a computer. The method further includes displaying broadcast content to at least one consumer via software executing on a computer. The method further includes querying at least one consumer for personal information and comments on the content via software executing on a computer. The method further includes tracking the activities of at least one consumer via software executing on a computer. The method further includes transmitting the tracked activities to a third party.

As stated above, social media and broadcast are done on two separate platforms and thus utilize twice the manpower and resources and fail to provide immediate or direct interaction with the viewer/customer. The current models (Facebook, Twitter etc) are not customizable or modifiable by the user. The system claimed here solves this problem.

The system (in some embodiments, a software package) provides both broadcast and social media together on one website 10 and eliminates the limitation of using third-party social media to conduct communication with viewers/content creators. Also, the software community environment can be modified and tailored to the specific business niche as opposed to using Facebook, Twitter or the like.

The system gives the power and access to the company licensing the software directly which is much more efficient and directly benefits them rather than the third-party company being the pipeline for communication/interaction. Moreover, instead of having separate components, all of the components can be packaged together to easily set up, maintain, and use.

The system may include at least one computer with a user interface. The computer may include at least one processing unit with a form of memory including, but not limited to, a desktop, laptop, and smart device, such as, a tablet and smart phone. The computer may include proprietary software including a machine-readable program code for causing, when executed, the computer to perform steps. The proprietary software may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

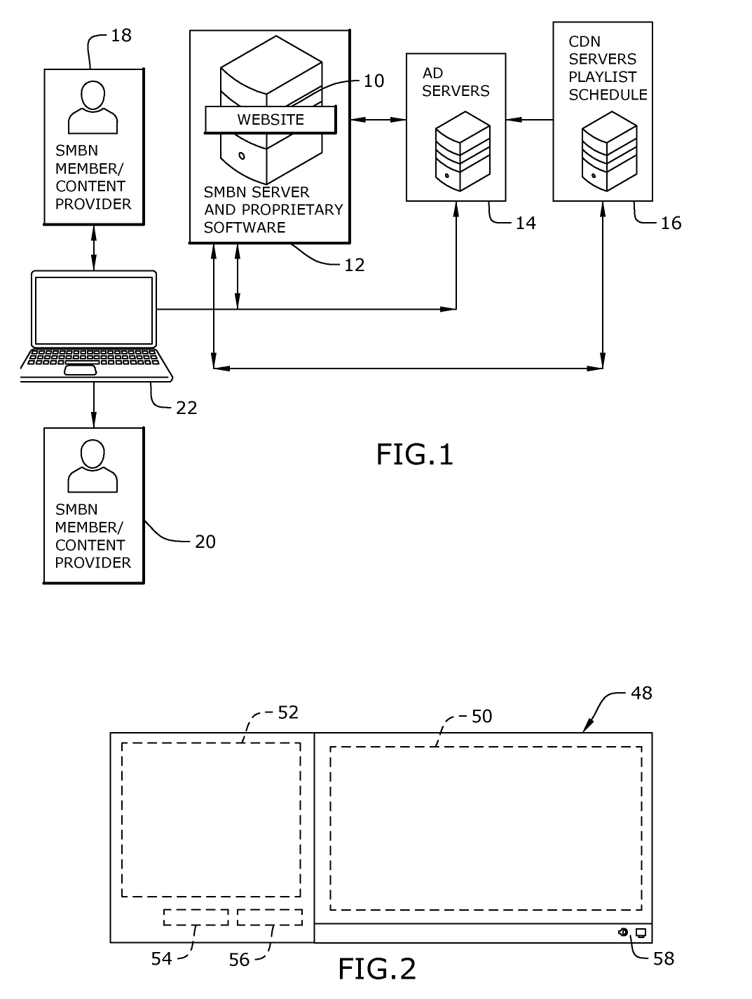

FIG. 1 shows a diagram of the components of the system, which include the following:

1. At least one broadcast category specific website 10

2. Social media network software component, smbn servers 12

3. CDN Streaming servers 16

4. At least one access device, such as a computer 22

5. At least one smbn member/content provider 18

6. At least one viewer 20

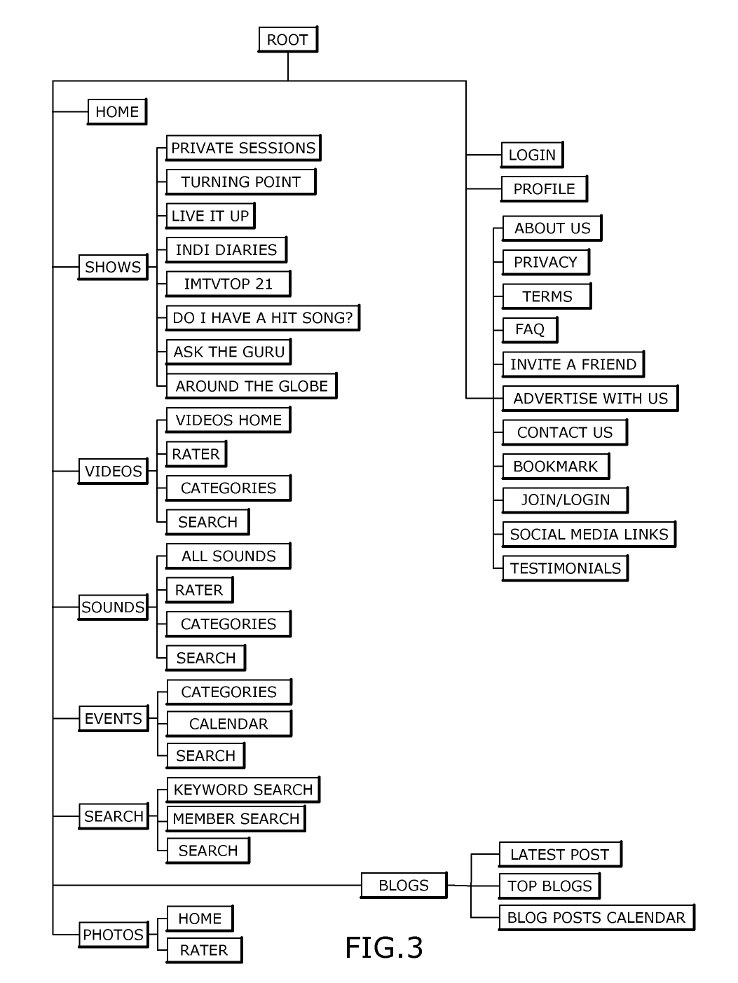

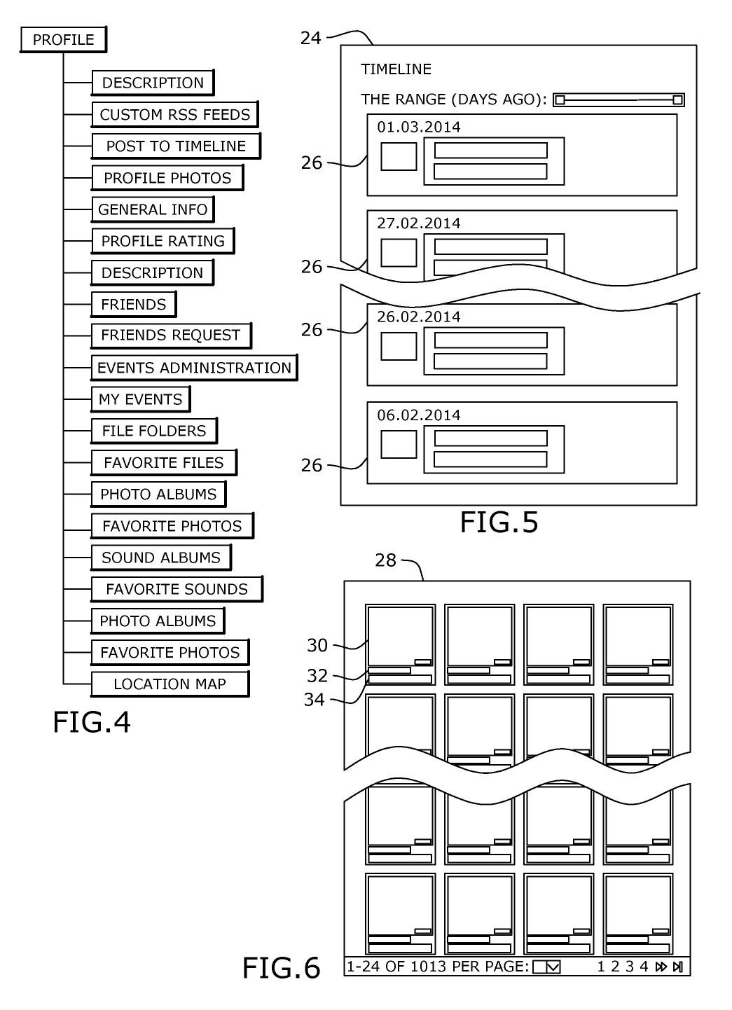

The system further includes an ad server 14 and proprietary software for executing on the smbn server 12. The viewer 20 accesses the website 10 via software executing on the computer 22 to view the broadcasting content and social media (hosted on the smbn server 12) via a video embedded player that streams to the homepage of the site. CDN servers 16 send broadcast media to the viewers (ad-free in certain embodiments). The user's metrics are recorded and sent to the ad server 14, which is marketable and generates revenue for the website operator. Members and content providers 18 can also access the servers through the website 10 via software executing on the computer 22. FIGS. 3 and 4 illustrate site maps of the website 10 and members' section thereof.

The website 10 may be specific to a certain genre of broadcasting content, such as music in this embodiment. In other embodiments, the content could be sports, TV shows, movies, and the like. The website 10 establishes the virtual portal/“Store front” for all users/subscribers/members to create their profile, upload and share their content and comments and interact regarding within the specific brand contents. The website 10 streams/broadcasts the site specific content that is uploaded to the server 24/7 worldwide to consumers. The website 10 broadcasts all approved video content uploaded to the video server. A video player is embedded on the website 10 from the video server to deliver the broadcast to the site users/visitors.

FIG. 2 shows a user interface/broadcast video player/ broadcast display frame 48 that may be shown on the homepage. The broadcast display frame 48 may include a play region 50, a text display region 52, a member area button 54, a join button 56, and control elements 58. As a result, the main website 10 via the broadcast display frame 48 may provide top media content, testimonials, some ad space, a login, some information to direct users, some video content, member pages and news, and is the user portal into the system. FIGS. 5-8 show screen views or screenshots of certain embodiments of the main website 10 that incorporates social media and broadcasting that can be provide by the broadcast display frame 48.

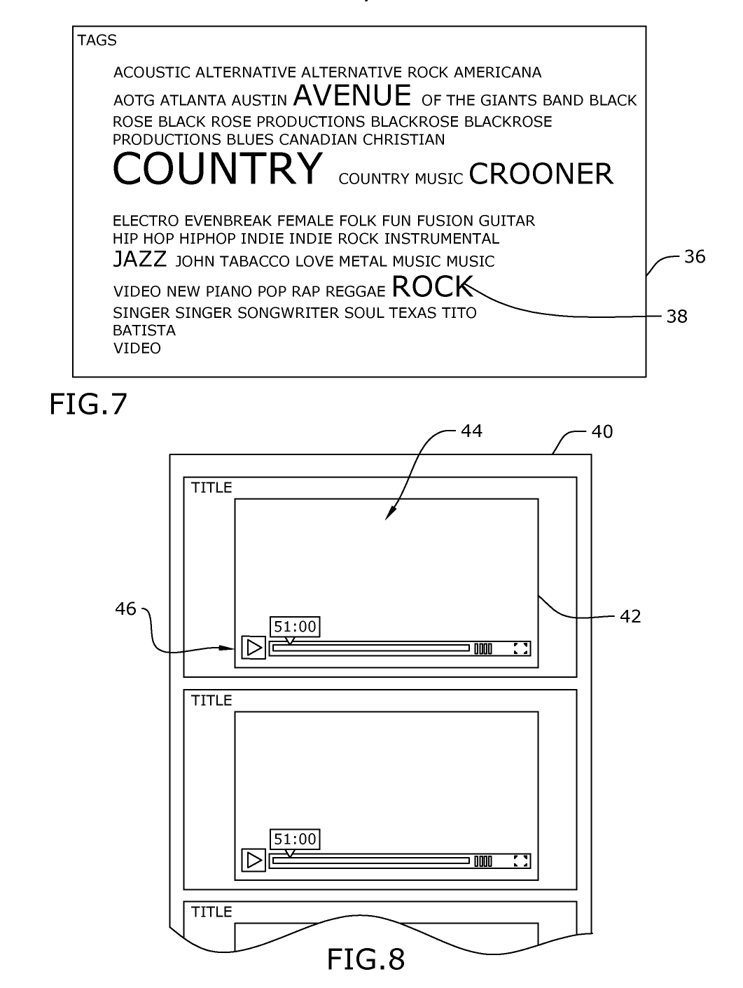

FIG. 5 is a screen view or screenshot of a time line social media display of the website 10, which shows a timeline frame 24 and a timeline entry 26 of a member page of the website 10 for users to set up a social media profile for themselves on the website 10, wherein the member page may further include a section for the profile description, photos, a main profile photo, an actions section, ad space, general info, a description, a profile ratings counter, a map with a location, a wall, and custom RSS feeds. FIG. 6 is a screen view or screenshot of a image/video tile broadcast display of the website 10, which shows a image tile display frame 28, a plurality of content images 30 each with a content creator title block 32 and content title block 34. FIG. 7 is a screen view or screenshot of a word/tag cloud tile display of the website 10, which shows a tag cloud 36 including a plurality of tags 38 from various users of the website 10. FIG. 8 is a screen view or screenshot of a video tile broadcast display of the website 10, which includes a broadcast display frame 40, an embedded video player 42, a video play region 44, and video playback controls 46. The video tile broadcast display and/or the broadcast display frame 48 enable the broadcast of photos pages of the website 10 for showing photos and albums from various users; blog pages of the website 10 for showing the latest blog posts from various users; a original programming page of the website 10 for showing episodes of an original program produced by the website 10 operator and/or its affiliates and partners, and/or a video content page of the website 10 for posting videos by users or corporate contributors.

The ad server 14 provides the ad content and thus creates the revenue and the CDN server 16 provides the broadcast within the site software and elsewhere where the broadcast can be transmitted, combined with social media in one website 10. Being merged at the code level of the website 10 (not just two separate sites and models in sync) connects the metrics of both the broadcast and the social community in a whole new way.

By incorporating a site/genre specific social community with a broadcast portal, the users interact directly with the content creators and the company delivering the content as opposed to through a third-party company social network such as Facebook, Twitter, and the like. This system is much more efficient and immediate for the visitors than those and content creators than those systems, because all information is exchanged directly between the user and the content creator. This provides the consumers and content generators greater security, content control, efficiency, and experience. Moreover, the website 10 engages users by allowing them to comment on, interact/communicate with and “like” broadcast content. This creates an environment where users can simultaneously socially interact and enjoy broadcast media, resulting in an engrossing user experience. All the while, revenue is being generated by tracking user ad metrics. All done in one place solves the problem of syncing the platforms, save time and creates many synergies that currently do not exist as separate platforms.

Individuals or companies can use the system to broadcast and garner a much broader, farther reaching, and more direct relationship with new and existing customers/viewers than any traditional model (i.e. YouTube, Vimeo, ROKU, Facebook, Twitter, and the like) provides. The systems and methods described herein take the best of all these models and combine them in a uniquely synergistic way.

The system can also be used as a closed environment between companies and their employees to converse, update and share company specific data, projects, and the like. Moreover, it can be used in the medical profession to create a nexus between the patient and the doctor to discretely share information, make a diagnosis and share pictures/video of specific illness related content without going through a public portal such as Facebook, Twitter, YouTube, and the like.

Bringing social media and broadcasting together gives the broadcaster direct access to the viewer/user as opposed to the third-party controlling and compiling information about all aspects of the user by having the user as their member, not a member of a third-party portal (Facebook, Twitter, and the like). The system retains the power, immediacy, control and communication information rather than the third-party company. The system gives the power and access to the company licensing the software directly which is much more efficient and directly beneficial as opposed to the traditional model were a third-party company is the pipeline for communication and interaction.

Although the invention has been described with reference to embodiments herein, those embodiments do not limit the invention. Modifications to those embodiments or other embodiments may fall within the scope of the invention.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for distributing broadcast media over the internet, comprising:
(a) providing a website containing broadcast content via software executing on a computer;
(b) generating a website account for at least one media consumer via software executing on a computer;
(c) displaying broadcast content to the at least one media consumer via software executing on a computer; and
(d) tracking the activities of the at least one media consumer via software executing on a computer.

2. The method of claim 1, wherein the broadcast content is a single genre.

3. The method of claim 1, further comprising querying the at least one media consumer for personal information and comments on the content via software executing on a computer.

4. The method of claim 1, further comprising transmitting the tracked activities to a third party.

5. The method of claim 1, further comprising establishing a virtual portal for the at least one media consumer to create their profile.

6. The method of claim 1, wherein the broadcast content comprises ad content.

7. The method of claim 6, wherein the ad content is provided by at least one ad server and the broadcast content is provided by at least one cdn server, and wherein each ad server and cdn server are merged at the code level.

8. A method for distributing broadcast media over the internet, comprising:
(a) providing a website containing a single genre of broadcast content via software executing on a computer;
(b) generating a website account for at least one media consumer via software executing on a computer;
(c) displaying broadcast content to the at least one media consumer via software executing on a computer;
(d) querying the at least one media consumer for personal information and comments on the content via software executing on a computer;
(e) tracking the activities of the at least one media consumer via software executing on a computer; and
(f) transmitting the tracked activities to a third party.

9. The method of claim 8, wherein the broadcast content comprises ad content.

10. The method of claim 9, wherein the ad content is provided by at least one ad server and the broadcast content is provided by at least one cdn server, and wherein each ad server and cdn server are merged at the code level.
